(19) United States
(12) Patent Application Publication
(10) Pub. No.: US 2017/0028657 A1
(43) Pub. Date: Feb. 2, 2017

(54) OPTICAL ELEMENT MANUFACTURING METHOD

(71) Applicant: NGK INSULATORS, LTD., Nagoya-City (JP)

(72) Inventors: Keiichiro ASAI, Nagoya-City (JP); Shoichiro YAMAGUCHI, Ichinomiya-City (JP); Jungo KONDO, Miyoshi-City (JP); Toshihiro TOMITA, Nagoya-City (JP)

(73) Assignee: NGK INSULATORS, LTD., Nagoya-City (JP)

(21) Appl. No.: 15/291,310

(22) Filed: Oct. 12, 2016

Related U.S. Application Data
(63) Continuation of application No. PCT/JP2015/062187, filed on Apr. 22, 2015.

(30) Foreign Application Priority Data
May 2, 2014 (JP) 2014-095134

(51) Int. Cl. B29D 11/00; G02B 5/18; B29C 59/02

(52) U.S. Cl. CPC B29D 11/0074; B29C 59/022; G02B 5/1857; B29L 2011/00

(57) ABSTRACT

It is produced an optical element including a support substrate, a clad layer provided on the support substrate, an optical material layer provided on the clad layer and a fine pattern formed in the optical material layer. The optical element has a warpage of +70 μm or more and +2.0 mm or less. At least a resin layer is formed on the optical material layer. It is used a mold with a design pattern corresponding to the fine pattern formed therein. The design pattern is transferred to the resin layer by an imprinting method. The fine pattern is formed in the optical material layer by a dry etching method. The mold is capable of being deformed conforming to a curve of the resin layer.

### TECHNICAL FIELD

The present invention relates to a method for producing an optical element such as a grating element and so forth.

### BACKGROUND ARTS

It has been examined to use a nanoimprinting method as a method for forming a diffraction grating possessed by a semiconductor laser element. Adoption of the nanoimprinting method for forming the diffraction grating has an advantage that manufacturing costs of devices such as semiconductor laser and so forth can be reduced.

When forming a diffraction grating by a nanoimprinting method, a resin layer is first formed on a semiconductor layer to form the diffraction grating. Then, a mold possessing the pattern of grooves and bumps corresponding to shape of this diffraction grating is pressed to this resin layer, and the resin layer is cured in that state. In this manner, the pattern of grooves and bumps of the mold is transferred to the resin layer. Then, a fine structure is formed in a semiconductor layer by transferring the shape of this resin layer to the semiconductor layer.

A method for producing a distributed feedback semiconductor laser using a nanoimprinting method has been disclosed in PATENT DOCUMENT 1. In this method, patterning a semiconductor layer for a diffraction grating of the distributed feedback semiconductor laser is carried out by the nanoimprinting method.

Further, preparation of a sub-wavelength structure wide-band wave plate using a nanoimprinting method has been disclosed in each of NON-PATENT DOCUMENT 1 and NON-PATENT DOCUMENT 2.

Further, it has been disclosed in NON-PATENT DOCUMENT 3 that a nanoimprint technology is applied to prepare optical devices. A wavelength selective element, a reflection controlling element, a moth-eye structure and so forth are exemplified as such optical devices.

### PATENT DOCUMENT

PATENT DOCUMENT 1: JP 2013-016650A

PATENT DOCUMENT 2: JP 2009-111423A

### NON-PATENT DOCUMENT

NON-PATENT DOCUMENT 1: “KONICA MINOLTA TECHNOLOGY REPORT” Vol. 2 (2005) pages 97-100 “Polymeric Wide-band Wave Plate Produced via Nanoimprint Sub-wavelength Grating”

NON-PATENT DOCUMENT 2: “Synthesiology” Vol. 1, No. 1 (2008) pages 24-30 “A challenge to the low-cost production of highly functional optical elements—Realisation of sub-wavelength periodic structures via glass-imprinting process—”

NON-PATENT DOCUMENT 3: Monthly DISPLAY June Issue (2007) pages 54-61 “Nanoimprint technology and its application to optical devices”

### SUMMARY OF THE INVENTION

The inventors tried to form an optical waveguide layer via a clad layer on a support substrate, and to form grooves and bumps with a pitch of several hundreds nm (Bragg grating pattern) on the surface of the optical waveguide layer. In this case, conventionally, exposure is to be performed by using EUV, ArF or KrF stepper exposure, or EB lithography. Then, a resin layer is subjected to patterning and is taken for a resin mask, or a metal layer present under the resin layer is subjected to patterning and is taken for a metal mask, and the pattern is formed on the surface of the underlying optical waveguide layer by etching.

However, when making an attempt to form the predetermined fine pattern in the optical waveguide layer, it has been understood that the following problem occurred. That is to say, because there is a considerable warpage in the support substrate and the optical waveguide layer provided thereon, it has been found that it occurs in some places to be out of focus when performing the stepper exposure or EB exposure, and thus no fine pattern can be formed.

On the other hand, application of the nanoimprinting method was tried to be taken into consideration, but in this case as well, it was difficult to transfer patterns because a distance between the pattern transfer surface of the mold and the surface of the optical material layer did not become constant.

An object of the present invention is, in producing an optical element including a support substrate, a clad layer, an optical material layer and a fine pattern formed in the optical material layer, to prevent failure of the fine pattern while highly maintaining adhesion of the optical material layer to the support substrate.

The present invention provides a method for producing an optical element comprising a support substrate, a clad layer provided on the support substrate, an optical material layer provided on the clad layer and a fine pattern formed in the optical material layer. The method comprising the steps of:
forming at least a resin layer on said optical material layer;
using a mold with a design pattern corresponding to said fine pattern therein to transfer said design pattern to the resin layer by an imprinting method; and
forming the fine pattern to the optical material layer by a dry etching method,
wherein the optical element has a warpage of +70 μm or more and +2.0 mm or less, and
wherein the mold is capable of being deformed conforming to a curve of the resin layer.

The present invention further provides a method for producing an optical element comprising a support substrate, a clad layer provided on the support substrate, an optical material layer provided on the clad layer and a fine pattern formed therein in the optical material layer. The optical element has a warpage of +70 μm or more and +2.0 mm or less. The method comprising the steps of:
forming at least a resin layer on the optical material layer;
using a mold with a design pattern corresponding to the fine pattern therein to transfer the design pattern to the resin layer by an imprinting method plural times while the mold is moved; and
forming the fine pattern in the optical material layer by a dry etching method.

The present inventors have examined the reason why an optical substrate possessing a support substrate, a clad layer, and an optical material layer is warped, and the following knowledge has been obtained.

That is to say, in cases where an optical material layer was formed in such a manner that adhesion between the optical material layer and a support substrate became low when producing an optical element possessing a fine pattern formed in the optical material layer, adhesion at the interface of each layer was poor, and a phenomenon of deterioration of optical characteristics and reliability caused by generation of film peeling was observed. Thus, it is preferred to enhance adhesion between the optical material layer and the support substrate. However, in cases where a clad film is film-formed on a support substrate and the optical material layer is formed thereon to form the optical substrate, warpage caused by film stress occurs in the optical substrate. It has been seen that the higher the adhesion between the optical material layer and the support substrate is, the larger the warpage tends to be.

In this instance, in the case of stepper exposure, when warpage of the optical substrate exceeded 10 μm, it was not made enough to bring into focus, thereby generating portions where exposure failure was generated. In the case of EB lithography as well, when the warpage of the optical substrate exceeded 100 μm, exposure failure errors were similarly generated, and thus it was understood that even in the case of a warpage of 70 μm or less, portions of exposure failure were generated. The grating pattern caused by such an exposure failure is exemplified in FIG. 9.

For this reason, the present inventor set to highly maintain adhesion between the support substrate and the optical material layer, based on the premise that the optical substrate was appropriately warped. At the same time, an imprinting method was employed, and in this case, a mold capable of being deformed conforming to a curve of the optical material layer was employed as a mold for imprinting. Thus, it was realized to suppress fine pattern failure.

Further, the present inventors have tried to perform plural times a process of transferring a design pattern to a resin layer by an imprinting method, by moving the mold, based on the premise that the optical substrate is appropriately warped. Because in each transferring step, only a part of each of the intended fine patterns is only transferred, width of the design pattern transferred by transferring once can be reduced, and thus a warpage amount corresponding to the width of the mold can be suppressed within an allowable range required for the transferring. Thus, it was realized to suppress fine pattern failure.

### BRIEF DESCRIPTION OF THE DRAWINGS

FIG. 1 is a schematic diagram showing a state where a warped optical substrate 1 is subjected to stepper exposure.

FIG. 2 is a schematic diagram showing a state where a warped body 10 to be processed is subjected to imprinting processing using a flexible mold 6.

FIG. 3 is a schematic diagram showing a state where a warped body 10 to be processed is subjected to imprinting processing using a small-sized mold 7.

FIG. 4 is a schematic diagram showing a state where a warped body 10 to be processed is subjected to imprinting processing while changing the position of the small-sized mold 7.

FIG. 5 is a diagram schematically showing a state where a design pattern of the mold 6 is transferred to a resin layer.

FIG. 6 is a schematic diagram showing a state where a resin layer and an optical material layer have been molded by dry etching.

FIG. 7 is a schematic diagram showing an optical element 12.

FIG. 8 is a photograph showing a grating pattern obtained in Example.

FIG. 9 is a photograph showing a grating pattern which has resulted in exposure failure.

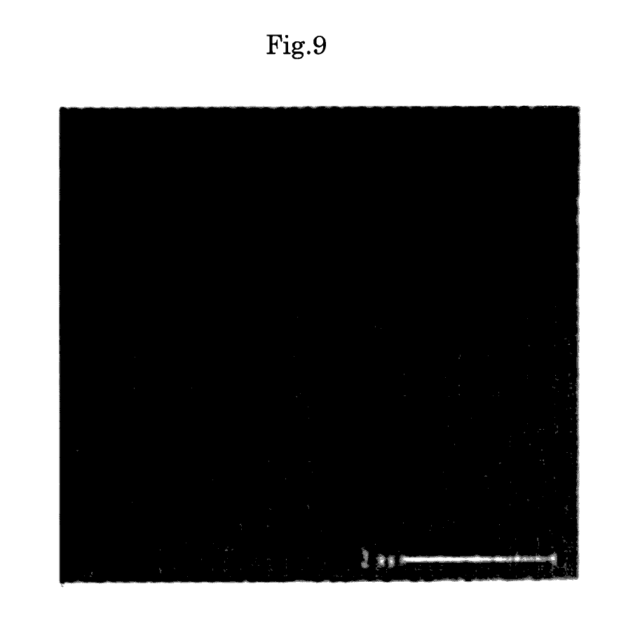

FIG. 10(a) shows a measurement method in the case where a sample has a positive numerical value of warpage, and FIG. 10(b) shows a measurement method in the case where a sample has a negative numerical value of warpage.

### EMBODIMENTS FOR CARRYING OUT THE INVENTION

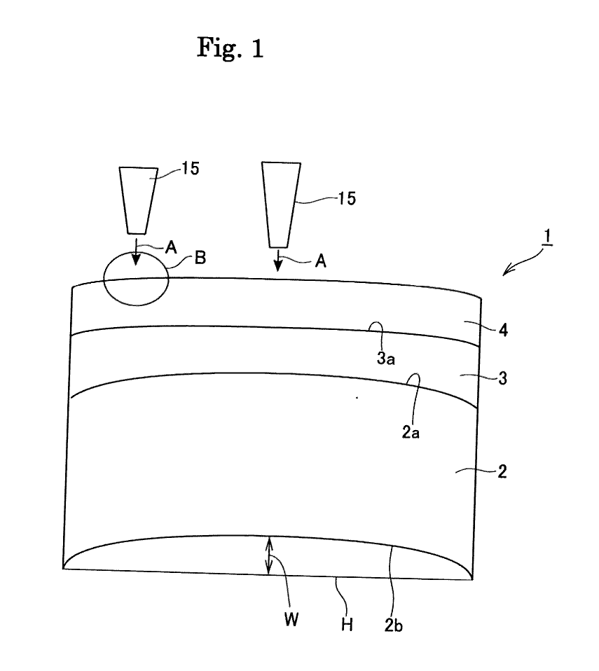

As shown in FIG. 1, an optical substrate 1 possesses a support substrate 2, a clad layer 3 provided on an upper surface 2a of the support substrate 2, and an optical material layer 4 provided on an upper surface 3a of the clad layer. In the present invention, the optical substrate 1 is adjusted to have a warpage of +70 μm or more and +2.0 mm or less, and adhesion of the optical material layer 4 to the support substrate 2 is high, thereby preventing the occurrence of film peeling.

In addition, the warpage W of the optical substrate 1 means the maximum value of a space between a horizontal plane H and a bottom surface 2b of the optical substrate 1, when setting the horizontal plane H as a reference. After forming a fine pattern in the optical material layer in the optical substrate 1 to obtain an optical element, a warpage of the optical element is substantially maintained.

When performing stepper exposure or EB exposure, the optical material layer 4 is exposed to light as indicated by an arrow A, using a lens 15, and a predetermined design pattern needs to be formed in the optical material layer 4. Herein, when a warpage of the optical substrate exceeded 10 μm, it was not made enough to bring into focus, thereby generating portions where exposure failure was generated. For example, in FIG. 1, even though bringing into focus at the center part of the optical material layer 4, it occurs to be largely out of focus at the end potion of the optical material layer 4, and thus it is that exposure failure is generated in a region B.

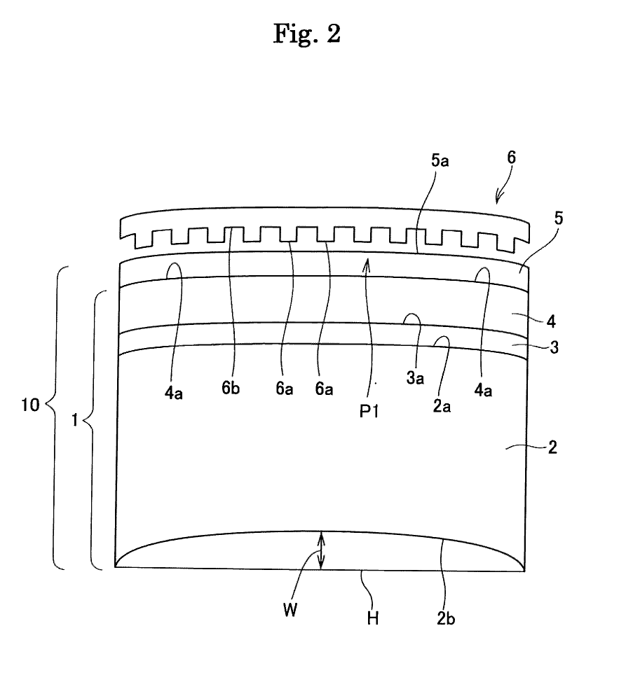

In the present invention, for example, as shown in FIG. 2, a resin layer 5 is formed on an optical substrate 1 to obtain a body 10 to be processed. Then, a mold 6 capable of being deformed following a curve of the resin layer 5 is employed as a mold for imprinting. Bump portions 6a and groove portions 6b are formed periodically and alternately on the molding surface of a mold 6, and a design pattern P1 is constituted. The design pattern is transferred to the resin layer by imprinting this mold onto a surface 5a of the resin layer 5.

In this way, even though the optical substrate 10 is warped, so that the resin layer 5 is curved, it becomes possible that the design pattern is evenly transferred with high accuracy over the whole pattern forming surface of the resin layer 5, by making use of a mold 6 capable of being deformed following a curve of the resin layer 5.

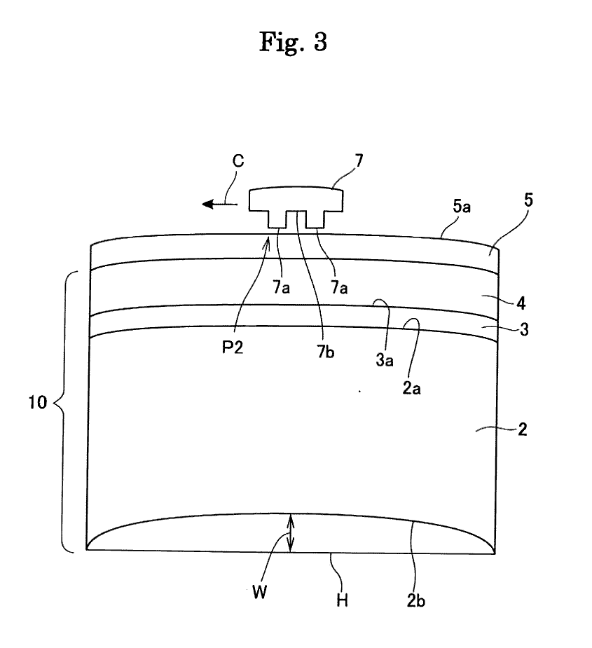

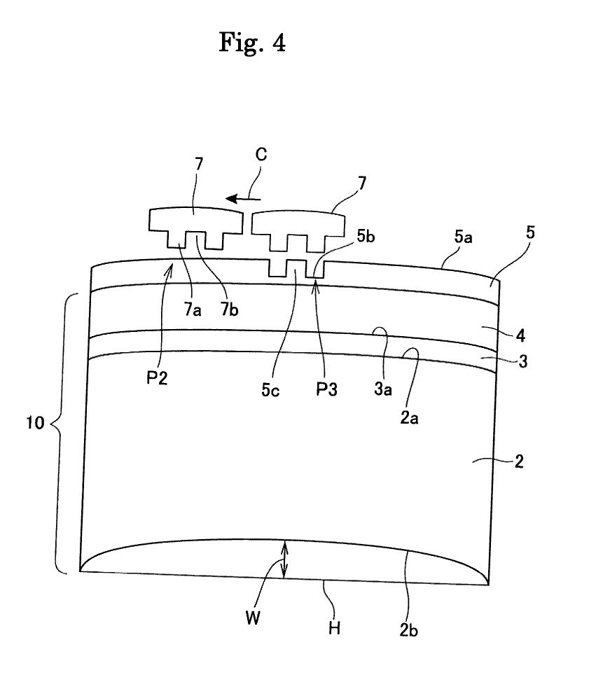

Alternatively, a mold 7 for which a design pattern P2 corresponding to a part of the fine pattern is formed is used, as shown in FIG. 3. The mold 7 has smaller width than that of the resin layer. Then, after performing a step of transferring the design pattern to the resin layer 5 by an imprinting method, the mold is moved as indicated by an arrow C to fix the mold at the neighboring position as shown in FIG. 4, and the design pattern P2 is transferred to the resin layer 5 again by an imprinting method. Symbol 7a represents a bump portion, and symbol 7b represents a groove portion.

In this manner, even though the optical substrate 10 is warped so that the resin layer 5 is curved, it becomes possible that the design pattern is evenly transferred with high accuracy by making use of the mold 7 for which the design pattern corresponding to a part of the fine pattern is formed, and repeating the transferring while moving the mold, because a width of the design pattern to be transferred at a time can be reduced.

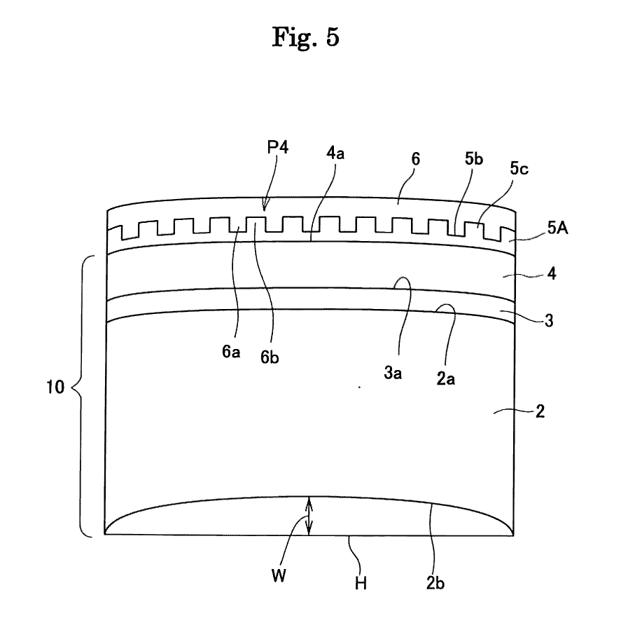

As exemplified in FIG. 5, when transferring the design pattern of the mold, the molding surface of the mold 6 is brought into contact with the resin layer to transfer the design pattern P1 to the resin layer, and the pattern P4 of bump portions 5c and groove portions 5b is formed in the resin layer 5A. Further, as exemplified in FIG. 4, the molding surface of the mold 7 is brought into contact with the resin layer to transfer the design pattern P2 to the resin layer, and the pattern P3 of bump portions 5c and groove portions 5b is formed in the resin layer.

In the case where the resin layer is made of a thermoplastic resin, the resin layer 5 is softened by heating the resin layer to the softening point of the resin or higher, and the resin can be deformed by pressing the mold thereto. The resin layer is cured during cooling that follows. In the case where the resin layer is made of a thermosetting resin, the resin is deformed by pressing the mold to an uncured resin layer 5, and can be subsequently cured by heating the resin layer to the polymerization temperature of the resin or higher. In the case where the resin layer 5 is formed of a photo curable resin, deformation is produced by pressing the mold to the uncured resin layer 5 to transfer the design pattern, and curing can be carried out by exposing the resin layer 5 to light.

Further, as shown in FIG. 3 and FIG. 4, in the case also where the design pattern is transferred to the resin layer while moving a mold, the resin layer 5 is softened by heating, and the resin can be deformed by pressing the mold thereto. Alternatively, in the case where the resin layer 5 is formed of a photo curable resin, deformation is produced by pressing the mold to the resin layer 5 before curing to transfer the design pattern, and curing can be carried out by exposing the resin layer 5 to light.

After transferring the design pattern to the resin layer, the optical material layer is etched by a dry etching method, and the fine pattern is molded in the optical material layer.

Examples of the dry etching thereof include reactive etching and so forth, for example, and as gaseous species, fluorine based and chlorine based ones may be exemplified.

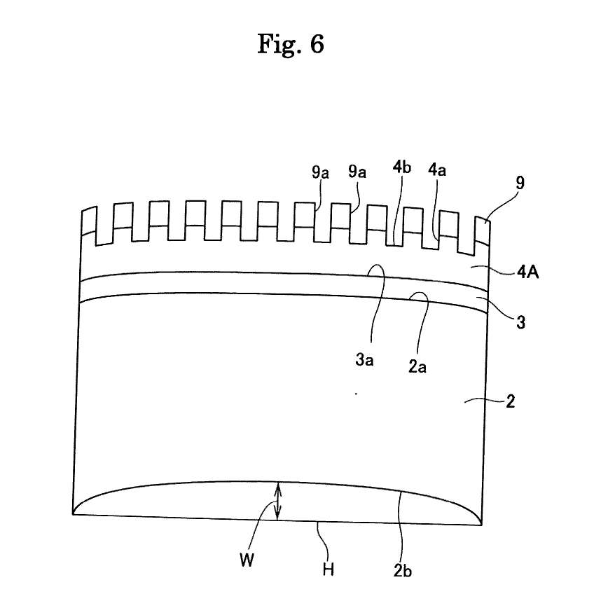

The case where the resin layer is utilized as a mask will be described. As shown in FIG. 5, a resin remains on the bottom of the groove portion of the resin layer 5A. This remaining resin is removed therefrom by ashing, and the form shown in FIG. 6 is taken. In FIG. 6, a number of through-holes 9a are formed in a resin mask 9, and an optical material layer 4 is exposed to the bottom of this through-hole 9A. Next, the resin mask as a mask is subjected to etching, and material of the optical material layer is partly removed therefrom to form the groove portions 4b in the optical material layer. Areas immediately below the resin mask 9 are not subjected to the etching, and thus they remain as bump portions 4a.

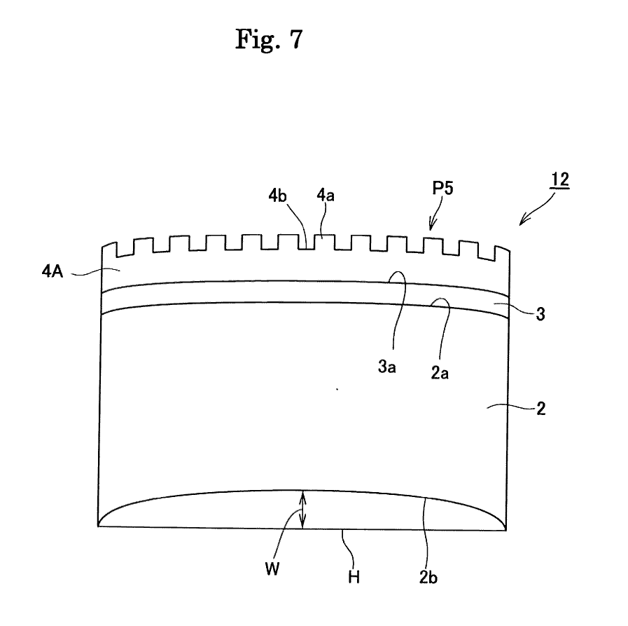

Next, the resin mask 9 is removed therefrom, and an optical element 12 is obtained as shown in FIG. 7. In the optical element 12, the fine pattern P5 of the bump portions 4a and groove portions 4b which are periodically formed is formed in an optical material layer 4A.

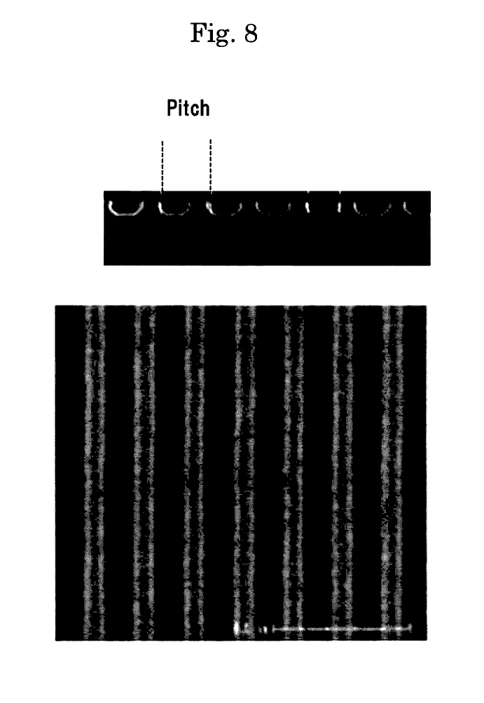

FIG. 8 shows a photograph of each of a cross section and a surface of the optical material layer in the resulting optical element. On the upper side, shown is the cross section, and it is understood that the bump portions and the groove portions are formed at fixed periods. On the other hand, on the lower side, shown is the surface, and it is understood that good grating pattern is formed.

Further, the case where another mask material layer is provided between the resin layer and the optical material layer will be described. In this case also, as previously mentioned, the design pattern is transferred to the resin layer. Next, the resin remaining on the bottom of the groove portion of the resin layer is removed therefrom by ashing to expose the mask material layer as a base thereto. It follows that the mask material layer is exposed to a space through the through-hole formed in the resin layer.

Next, the mask material layer is subjected to etching, and a number of through-holes are formed in the mask material layer depending on the design patterns to obtain a mask. Next, the material of the optical material layer immediately below the through-hole of the mask is removed therefrom by etching, and groove portions 4b as shown in FIG. 6 are formed. The optical material layer remains unchanged as it is immediately below the mask to form bump portions 4a. Subsequently, the unnecessary resin layer and mask are removed therefrom to obtain the optical element 12 shown in FIG. 7.

In addition, further, an upper side clad layer may be also provided on the surface of the optical material layer.

As described below, the configuration of an optical element will be further described.

In the present invention, the optical element has a warpage of +70 μm or more and +2.0 mm or less. In terms of the present invention, the optical element more preferably has a warpage of +100 μm or more, and more preferably has a warpage of +1 mm or less. Further, the warpage of the optical element means warpage of an integrated optical element as a whole regardless of plane dimensions of the optical element.

Further, the warpage of the optical element is represented by a value determined by the method which has been disclosed in JP 2009-111423A.

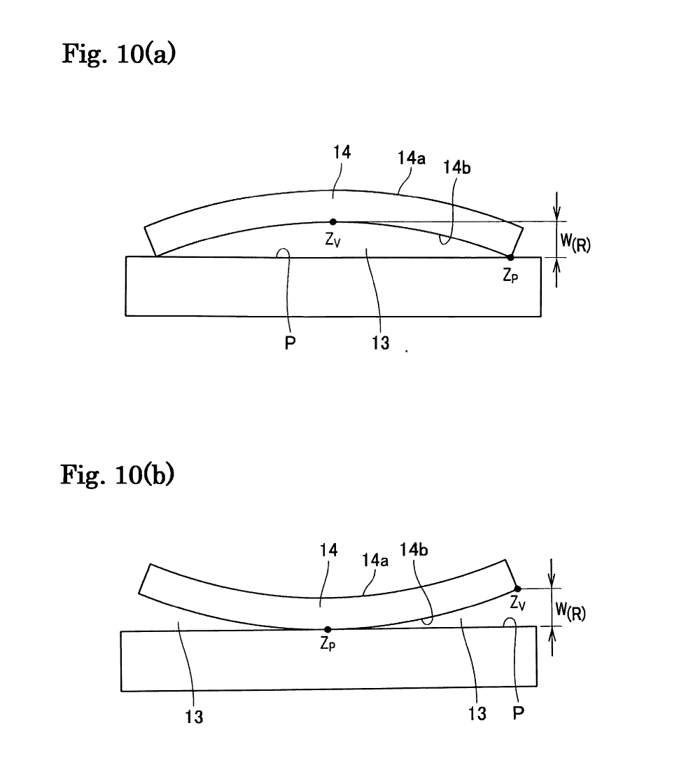

Specifically, these will be described referring to FIG. 10.

Herein, in the example shown in FIG. 10(a), a sample 14 is warped in such a manner that the bottom surface 14b of the sample 14 is recessed and the upper surface 14a thereof is protruded. This warpage is set to be positive (which is represented by a plus sign). Further, in the example shown in FIG. 10(b), the sample 14 is warped in such a manner that the bottom surface 14b of the sample 14 is protruded and the upper surface 14a thereof is recessed. This warpage is set to be negative (which is represented by a minus sign). The curved surface which the bottom surface 14b of the sample 14 forms is designated as “warpage curved surface”.

A surface which is set such that a mean value of distances between the warpage curved surface and a plane P is at a minimum is assumed to take this plane for an optimal plane P. Then, the distance between this warpage curved surface and the optimal plane P is measured. The point which is present on the optimal plane P among the bottom surface 14b is represented by Symbol “zp”. Further, the point which is the most distant from the optimal plane P among the bottom surface 14b is represented by Symbol “zv”. The distance between the point “zv” and the optimal plane P is represented by Symbol W(R) as the warpage. Numeral 13 represents a gap between a sample and the plane P.

In other words, W(R) as the warpage means a difference in heights between the point “zv” which is the most distant and the point “zp” which is closest to the optimal plane P in relation to the bottom surface 14b.

A mold exhibiting a property of capable of being deformed conforming to a curve of the optical material layer means that the mold is made of an easily deformable material. Films each made of a flexible material such as a resin or the like as such a material can be utilized. Preferable examples of such the material include PET (Polyethylene terephthalate), PC (polycarbonate) and polyolefin.

In terms of being deformed conforming to a curve of the optical material layer, and easy deformation thereof, a material property of the mold preferably has a Young's modulus of 40 GPa or less, and more preferably has a Young's modulus of 10 GPa or less.

Specific materials for the support substrate are not particularly limited, and lithium niobate, lithium tantalate, AlN, SiC, ZnO, a glass such as quartz glass or the like, synthetic quartz, quartz crystal, Si and so forth can be exemplified.

In terms of handling, the support substrate preferably has a thickness of 250 μm or more, and further, in terms of downsizing, the support substrate preferably has a thickness of 1 mm or less.

The optical material layer is preferably formed of an optical material such as silicon oxide, zinc oxide, tantalum oxide, lithium niobate, lithium tantalate, titanium oxide, aluminum oxide, niobium pentoxide, magnesium oxide or the like. Further, the optical material layer preferably has a refractive index of 1.7 or more, and more preferably has a refractive index of 2.0 or more.

In order to further improve optical damage resistance of the optical waveguide, at least one kind of metal element selected from the group consisting of magnesium (Mg), Zinc (Zn), scandium (Sc) and indium (In) may be contained in the optical material layer, and in this case, magnesium is specifically preferable. Further, a rare earth element may be contained in a crystal as a doping component. Nd, Er, Tm, Ho, Dy and Pr are specifically preferable as the rare earth element.

Thickness of the optical material layer is not specifically limited, but a thickness of 0.5-3 μm is preferable in terms of reducing a propagation loss of light.

The clad layer 3 and the upper side clad layer each are formed of a material having a lower refractive index than that of a material of the optical material layer, but may be formed of silicon oxide, tantalum oxide, a resin, or zinc oxide, for example. Further, the clad layer and the upper side clad layer each may be doped therewith to adjust the refractive index. P, B, Al and Ga can be exemplified as such a dopant.

As materials for the mask material layer, Cr, Ni, Ti, Al, tungsten silicide and so forth, and multilayer films thereof can be exemplified.

The optical material layer, the clad layer and the upper side clad layer each may be a single layer, but may also be a multilayer film.

In addition, a warpage correction film made of a material exhibiting the same thermal expansion coefficient as that of each of the clad layer 3 or the optical material layer 4 may be also formed on the bottom surface of the support substrate.

Further, the optical material layer, the clad layer and the upper side clad layer each may be film-formed by a thin film forming method. Sputtering, vapor evaporation, and CVD can be exemplified as such the thin film forming method. In this case, the optical material layer is directly formed on the support base, and there is no layer of adhesion as described above.

The fine pattern formed in the optical material layer means a pattern having a period of 10 μm or less, and is specifically effective for a pattern having a period of 1 μm or less. A sub-wavelength structure wide-band wave plate, a wavelength selective element, a reflection controlling element, a moth-eye structure, Bragg gratings, a ridge optical waveguide and so forth can be exemplified as the fine pattern formed in the optical material layer.

1. A method for producing an optical element comprising a support substrate, a clad layer provided on said support substrate, an optical material layer provided on said clad layer and a fine pattern formed in said optical material layer, the method comprising the steps of:
forming at least a resin layer on said optical material layer;
using a mold with a design pattern corresponding to said fine pattern therein to transfer said design pattern to said resin layer by an imprinting method; and
forming said fine pattern in said optical material layer by a dry etching method,
wherein said optical element has a warpage of +70 μm or more and +2.0 mm or less, and
wherein said mold is capable of being deformed conforming to a curve of said resin layer.

2. The method of claim 1, wherein said fine pattern comprises groove portions periodically formed on a surface of said optical material layer.

3. The method of claim 2, wherein said fine pattern comprises a Bragg grating.

4. A method for producing an optical element comprising a support substrate, a clad layer provided on said support substrate, an optical material layer provided on said clad layer and a fine pattern formed in said optical material layer, wherein said optical element has a warpage of +70 μm or more and +2.0 mm or less, the method comprising the steps of:
forming at least a resin layer on said optical material layer;
using a mold with a design pattern corresponding to said fine pattern therein to transfer said design pattern to said resin layer by an imprinting method plural times while said mold is moved; and
forming said fine pattern in said optical material layer by a dry etching method.

5. The method of claim 4, wherein said fine pattern comprises groove portions periodically formed on a surface of said optical material layer.

6. The method of claim 5, wherein said fine pattern comprises a Bragg grating.
